(19) United States
(12) Patent Application Publication
(10) Pub. No.: US 2025/0354586 A1
(43) Pub. Date: Nov. 20, 2025

(54) PRESS TOOL ASSEMBLIES, SYSTEMS, AND METHODS FOR INSERTING BUSHING ASSEMBLIES

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/282,805

(22) Filed: Jul. 28, 2025

Related U.S. Application Data
(63) Continuation of application No. 18/642,359, filed on Apr. 22, 2024, now Pat. No. 12,372,119.
(60) Provisional application No. 63/497,987, filed on Apr. 24, 2023.

(51) Int. Cl. F16C 43/02

(52) U.S. Cl. CPC F16C 43/02; F16C 2226/12

(57) ABSTRACT

A press tool system for pressing a bushing assembly along a structural axis defined by a structural member comprises a brace assembly, a drive member, a retaining sleeve defining a sleeve passageway, and an actuator system. At least a portion of the bushing assembly is arranged in the sleeve passageway. The brace assembly is configured to support the actuator system and drive member such that at least a portion of the brace assembly engages the actuator system and the structural assembly and at least a portion of the drive member engages the actuator system and the bushing assembly. Operation of the actuator system causes the retaining sleeve to engage the structural member and displace the drive member and bushing assembly at least partly through the sleeve passageway along the structural axis.

### RELATED APPLICATIONS

This application (Attorney's Ref. No. P220685) is a continuation of U.S. patent application Ser. No. 18/642,359 filed Apr. 22, 2024, currently pending.

U.S. patent application Ser. No. 18/642,359 claims benefit of U.S. Provisional Application Ser. No. 63/497,987 filed Apr. 24, 2023, now expired, the contents of which are incorporated herein by reference.

### TECHNICAL FIELD

The present invention relates to press tools for inserting bushing assemblies and, more particularly, to press tools for inserting bushing assemblies having non-metal bushing housings.

### BACKGROUND

Bushings form an energy absorbing interface between two metal objects. The bushing is typically made of a flexible material such as rubber, synthetic rubber, polyurethane, or the like. A typical bushing takes the form of a bushing assembly comprising a bushing housing and a bushing member arranged within the bushing housing.

As one example, in a vehicle suspension system, bushing assemblies are often used to attach a leaf spring to the chassis of the vehicle. The leaf spring defines a bushing opening, and the bushing assembly is driven or pressed in to the bushing opening using a press tool. The present invention is of particular relevance when used to assemble a bushing into an opening in a leaf spring, and that application of the present invention will be described herein. However, the press tool of the present invention may be used to insert bushings in other operating environments.

When the bushing housing is made of metal, the bushing assembly can be driven into the opening in the part that supports the bushing by applying a driving or pressing force to the bushing housing, which in turn carries the bushing member into the opening. However, a class of bushing assemblies employs a non-metal bushing housing. The use of a press to drive or press a non-metal bushing housing can result in a cracked or deformed bushing housing that may comprise the functionality of the bushing assembly. Special factory press systems and methods are used at the factory to install bushing assemblies having non-metal bushing housings. However, the use of such special press systems and methods is not feasible in a non-factory repair or maintenance shop environment.

The need thus exists for improved press tool assemblies, systems, and methods that can be used in repair or maintenance shop environments.

### SUMMARY

The present invention may be embodied as a press tool system for pressing a bushing assembly along a structural axis defined by a structural member comprises a brace assembly, a drive member, a retaining sleeve defining a sleeve passageway; and an actuator system. At least a portion of the bushing assembly is arranged in the sleeve passageway. The brace assembly is configured to support the actuator system and drive member such that at least a portion of the brace assembly engages the actuator system and the structural assembly and at least a portion of the drive member engages the actuator system and the bushing assembly. Operation of the actuator system causes the retaining sleeve to engage the structural member and displace the drive member and bushing assembly at least partly through the sleeve passageway along the structural axis.

The present invention may also be embodied as a method for displacing a bushing assembly along a structural axis defined by a structural member comprising the following steps. A brace assembly, a drive member, a retaining sleeve defining a sleeve passageway, and an actuator system are provided. At least a portion of the bushing assembly is arranged in the sleeve passageway. The brace assembly is configured to support the actuator system and drive member such that at least a portion of the brace assembly engages the actuator system and the structural assembly and at least a portion of the drive member engages the actuator system and the bushing assembly. The actuator system is operated to cause the retaining sleeve to engage the structural member and displace the drive member and bushing assembly at least partly through the sleeve passageway along the structural axis.

The present invention may also be embodied as a press tool system for displacing a bushing assembly defining a bushing axis along a structural axis defined by a structural member, the press tool system comprising a tool assembly defining a press axis and an actuator system. The tool assembly comprises a brace assembly, a drive member, and a retaining sleeve defining a sleeve passageway. The bushing assembly is at least partly arranged in the sleeve passageway such that the bushing axis is aligned with the press axis. The brace assembly is configured to support the actuator system and drive member such that the press axis is aligned with the structural axis, at least a portion of the brace assembly engages the actuator system and the structural assembly, and at least a portion of the drive member engages the actuator system and the bushing assembly. Operation of the actuator system displaces the drive member and bushing assembly along the press axis relative to the retaining sleeve and structural member until the bushing assembly is in a desired position defined by the structural member.

### BRIEF DESCRIPTION OF THE DRAWINGS

FIG. 1 is a perspective view illustrating the use of a first example press tool assembly and system of the present invention to insert a bushing assembly into a bushing opening in a leaf spring;

FIG. 2 is a side elevation exploded view of the first example press tool assembly and system, the bushing assembly to be inserted therewith, and a portion of the leaf spring defining the bushing opening;

FIG. 3 is a side elevation view of the example first example press tool assembly and system, the bushing assembly to be inserted therewith, and a portion of the leaf spring defining the bushing opening;

FIG. 4 is a side elevation partial section view of the example first example press tool assembly and system, the bushing assembly to be inserted therewith, and a portion of the leaf spring defining the bushing opening;

FIGS. 5 and 6 are side elevation section views depicting use the example first example press tool assembly and system to insert the bushing assembly in to the bushing opening; and

FIG. 7 is a side elevation section view illustrating the bushing assembly as installed in the bushing opening in the leaf spring.

### DETAILED DESCRIPTION

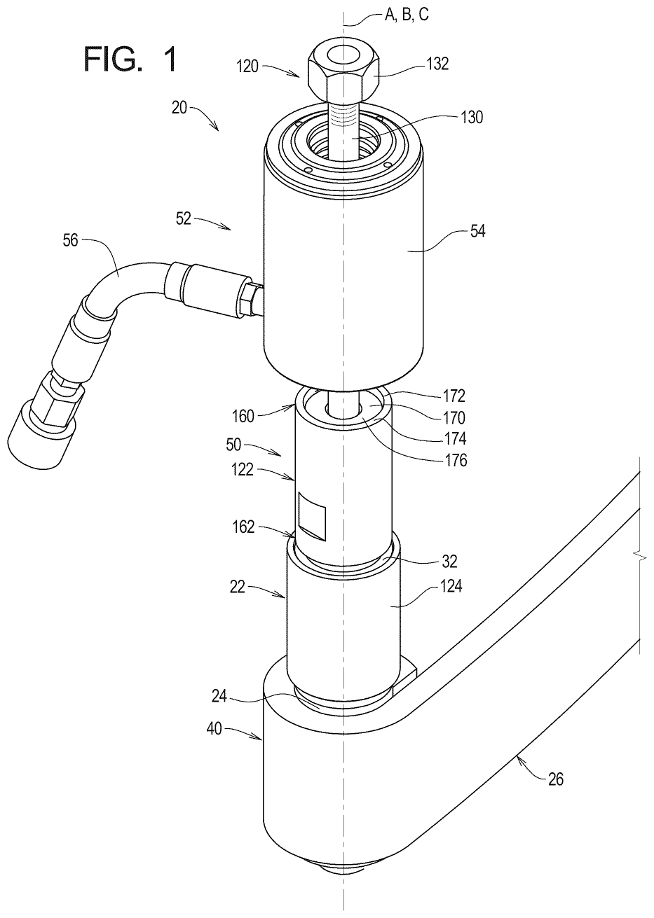

Referring initially to FIG. 1 of the drawing, depicted therein is a press tool system 20 configured to press a bushing assembly 22 into a bushing opening 24 formed in a structural member 26. The example structural member 26 is a leaf spring, but the present invention can be used with any structural member defining a bushing opening. The example bushing assembly 22 comprises a bushing member 30 coaxially mounted within a bushing housing 32. As is conventional, the example bushing member 30 defines a bushing passageway 34. The example structural member 26 defines a bushing support portion 40 defining the bushing opening 24. The example bushing assembly 22 and structural member 26 are or may be conventional and will be described herein only to that extent necessary for a complete understanding of the present invention.

The example press tool system 20 comprises a tool assembly 50 and an actuator system 52 comprising an actuator assembly 54 and a fluid supply line 56 connected to a fluid source (not shown). The example actuator assembly 54 comprises an actuator housing assembly 60 and a piston member 62. An actuator passageway 64 extends through the actuator housing assembly 60 and the piston member 62. Introduction of pressurized fluid from the fluid source through the fluid supply line 56 and into the actuator housing assembly 60 causes displacement of the piston member 62 relative to the actuator housing assembly 60.

The example tool assembly 50 comprises a brace assembly 120, a drive member 122, and a retaining sleeve 124. The drive member 122 is arranged to engage the piston member 62, the bushing assembly 22 is arranged within the retaining sleeve, and the retaining sleeve 124 is arranged between the drive member 122 and the bushing support portion 40. Operation of the actuator system 52 applies a drive or press force on the bushing assembly 22 through the drive member 122 and the retaining sleeve 124 such that the bushing assembly 22 is driven into the bushing opening 24.

The example brace assembly 120 comprises a brace rod 130, a brace nut 132, and an anchor nut 134. The example brace rod 130 defines a first threaded portion 140, a shaft portion 142, and a second threaded portion 144. The example anchor nut 134 defines a main portion 150, a flange portion 152, and an anchor passageway 154 defining a threaded portion 156 and a bushing portion 158.

The example drive member 122 defines an actuator end 160 and a drive end 162. The example actuator end 160 defines a piston engaging surface 170, and a spacing projection 172 extends from the example piston engaging surface 170 to define a housing engaging surface 174 and a piston cavity 176. The example drive end 162 defines a drive engaging surface 180, a drive projection 182. The drive engaging surface 180 and the drive projection 182 define a drive cavity 184.

The example 124 defines a first end 190, a second end 192, and a drive interior surface 194 defining a sleeve passageway 196.

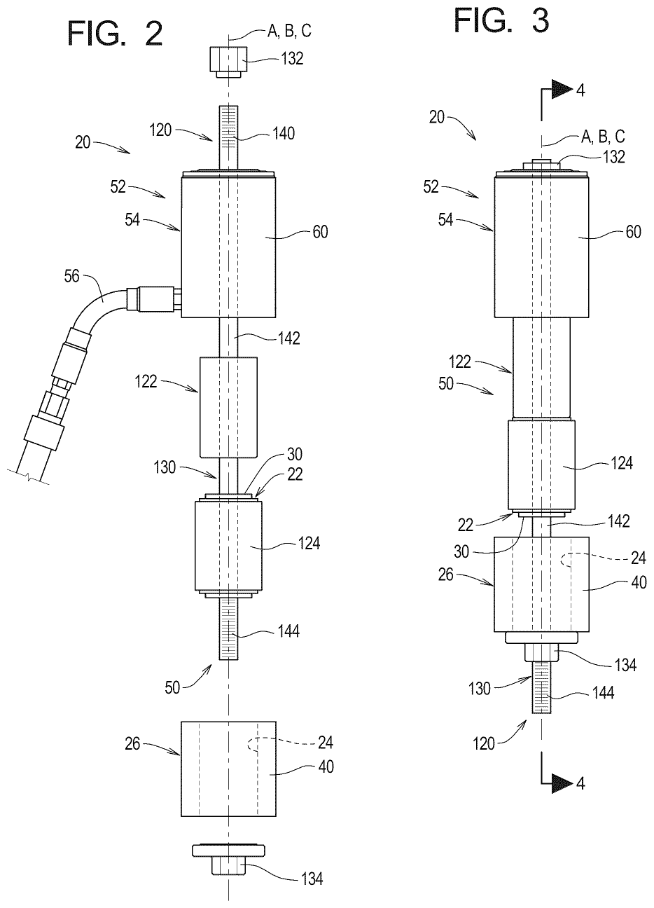

The example press tool system 20 defines a press axis A, the example bushing assembly 22 defines a bushing axis B, and the example bushing opening 24 defines a structural axis C. With the press axis A, the bushing axis B, and the structural axis C substantially aligned as shown in FIG. 2, at least a portion of the example brace rod 130 is passed through the actuator passageway 64, the drive cavity 164, the sleeve passageway 196, the bushing passageway 34, and the anchor passageway 154.

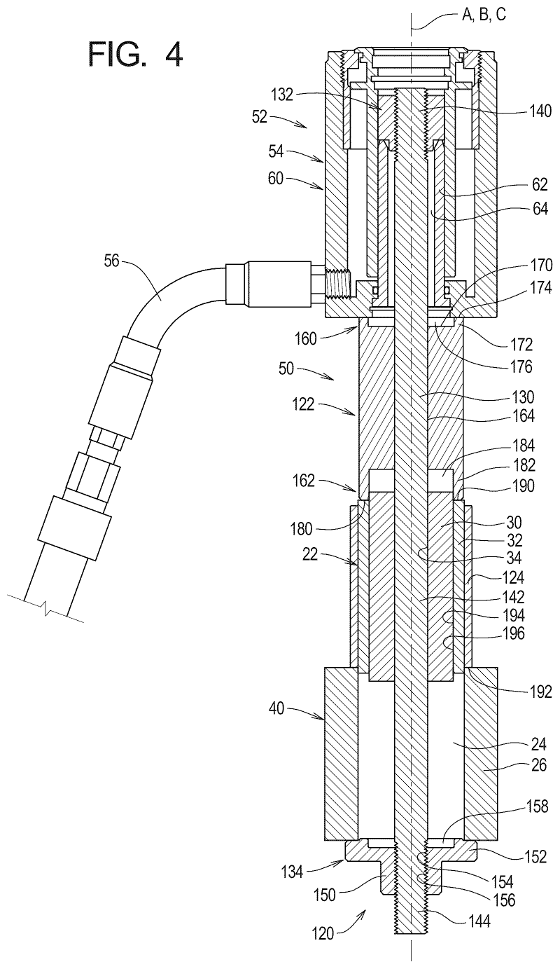

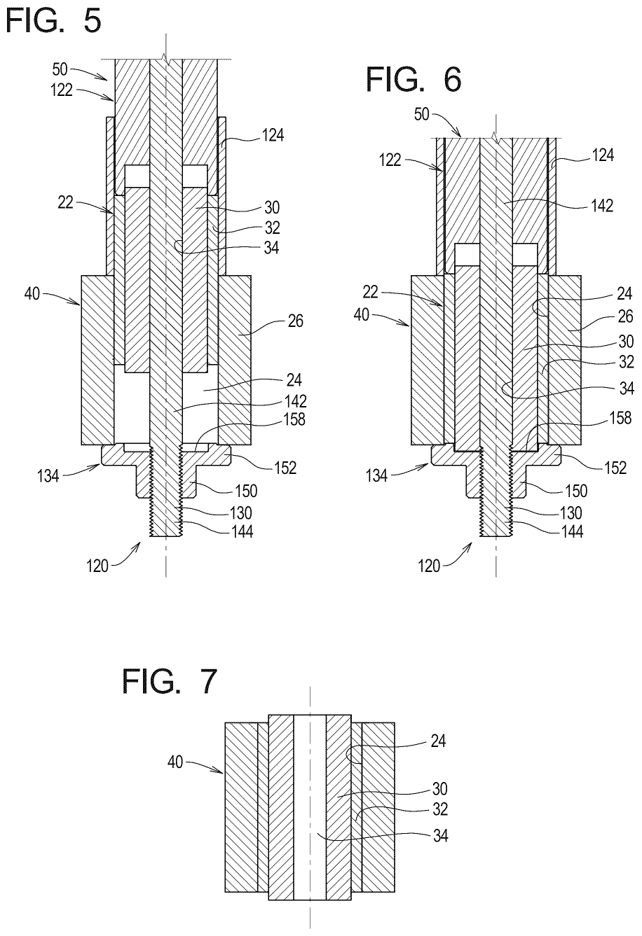

The brace nut 132 is secured to the first threaded portion 140 of the brace rod 130, and the anchor nut 134 is secured to the second threaded portion 144 of the brace rod 130. With the piston member 62 in a retracted position, the brace nut 132 and the anchor nut 134 are tightened such that the brace nut 132 engages the actuator housing assembly 60 and the flange portion 152 of the anchor nut 134 engages the structural member 26. As shown in FIGS. 3 and 4, the press axis A, the bushing axis B, and the structural axis C are all substantially aligned, and a distance between the brace nut 132 and the anchor nut 134 is substantially fixed.

Operation of the actuator system 52 displaces the piston member 62 relative to the actuator housing assembly 54 towards the structural member 26. Displacement of the piston member 62 displaces the drive member 122 towards the retaining sleeve 124 towards the structural member 26. Displacement of the drive member 122 displaces the bushing assembly 22 into the bushing opening 24.

During driving of the bushing assembly 22 into the bushing opening 24, the piston member 62 engages the piston engaging surface 170 of the drive member 122, the drive engaging surface 180 engages bushing housing 32, and the bushing housing 32 is completely surrounded by the retaining sleeve 124. The tolerances between the sleeve passageway 196 and an exterior surface of the bushing housing 32 are such that the bushing assembly 22 to be displaced through the retaining sleeve 124 but deformation or cracking of the bushing housing 32 during driving of the bushing assembly 22 is substantially prevented.

The actuator system 52 is operated until at least a portion of the bushing assembly 22 is within the bushing portion 158 of the anchor passageway 154. The example anchor bushing portion 158 is configured such that, when at least a portion of the bushing assembly 22 engages the anchor nut 134, the bushing assembly 22 is in a desired position relative to the structural member 26.

Disconnecting the source of pressurized fluid from the actuator system 52 and releasing pressurized fluid from the actuator assembly 54 removes the driving of pressing force from the bushing assembly 22. When the pressurized fluid is released, the brace and/or anchor nuts 132 and 134 may be removed from the brace rod 130 as shown in FIG. 7 allows the example tool assembly 50 to be disassembled and removed from the bushing assembly 22, leaving the bushing assembly 22 securely supported within the bushing opening 24 defined by the structural member 26.

What is claimed is:

1. A press tool system for pressing a bushing assembly along a structural axis defined by a structural member, the press tool system comprising:
a brace assembly;
a drive member;
a retaining sleeve defining a sleeve passageway; and
an actuator system; wherein
at least a portion of the bushing assembly is arranged in the sleeve passageway;
the brace assembly is configured to support the actuator system and drive member such that
at least a portion of the brace assembly engages the actuator system and the structural assembly, and
at least a portion of the drive member engages the actuator system and the bushing assembly;
operation of the actuator system causes the retaining sleeve to engage the structural member and displace the drive member and bushing assembly at least partly through the sleeve passageway along the structural axis.

2. The press tool system of claim 1, in which the brace assembly comprises a brace rod configured to support the drive member and bushing assembly such that when the actuator system is operated, the drive member and bushing assembly are displaced along the brace rod.

3. The press tool system of claim 1, in which the brace assembly comprises a brace rod and an anchor nut, whereby
the brace rod is configured to engage the actuator system,
the anchor nut is configured to engage the structural member and brace rod such that the actuator system maintains a maximum distance from the structural member.

4. The press tool of claim 3 in which the anchor nut defines an anchor passageway and the actuator system is configured to displace the drive member until at least a portion of the bushing assembly is arranged within the anchor passageway.

5. The press tool system of claim 1, in which the retaining sleeve defines a drive interior surface defining the sleeve passageway, wherein the drive interior surface is configured to engage the bushing assembly as the bushing assembly is displaced through the sleeve passageway.

6. The press tool system of claim 1, in which the actuator system comprises a piston member configured to engage the drive member as the actuator system is operated.

7. The press tool system of claim 1, in which the bushing assembly is displaced into a desired position defined by the structural member.

8. A method for displacing a bushing assembly along a structural axis defined by a structural member, the method comprising the steps of:
providing a brace assembly;
providing a drive member;
providing a retaining sleeve defining a sleeve passageway;
providing an actuator system;
arranging at least a portion of the bushing assembly in the sleeve passageway;
configuring the brace assembly to support the actuator system and drive member such that
at least a portion of the brace assembly engages the actuator system and the structural assembly, and
at least a portion of the drive member engages the actuator system and the bushing assembly;
operating the actuator system to cause the retaining sleeve to engage the structural member and displace the drive member and bushing assembly at least partly through the sleeve passageway along the structural axis.

9. The method of claim 8, in which the step of providing a brace assembly comprises providing a brace rod configured to support the drive member and bushing assembly such that when the actuator system is operated, the drive member and bushing assembly are displaced along the brace rod.

10. The method of claim 8, in which step of providing the brace assembly comprises:
providing a brace rod and an anchor nut;
configuring the brace rod to engage the actuator system; and
configuring the anchor nut to engage the structural member and brace rod such that the actuator system maintains a maximum distance from the structural member.

11. The method of claim 10, further comprising:
configuring the anchor nut to define an anchor passageway; and
configuring the actuator system to displace the drive member until at least a portion of the bushing assembly is arranged within the anchor passageway.

12. The method of claim 8, in which step of providing a retaining sleeve comprises:
configuring the retaining sleeve to defines a drive interior surface defining the sleeve passageway; and
configuring the drive interior surface to engage the bushing assembly as the bushing assembly is displaced through the sleeve passageway.

13. The method of claim 8, in which the step of providing an actuator system comprises:
providing a piston member; and
configuring the piston member to engage the drive member as the actuator system is operated.

14. The method of claim 8, further comprising displacing the bushing assembly until the bushing assembly is arranged in a desired position defined by the structural member.

15. A press tool system for displacing a bushing assembly defining a bushing axis along a structural axis defined by a structural member, the press tool system comprising:
a tool assembly defining a press axis, the tool assembly comprising
a brace assembly;
a drive member;
a retaining sleeve defining a sleeve passageway; and
an actuator system; wherein
the bushing assembly is at least partly arranged in the sleeve passageway such that the bushing axis is aligned with the press axis;
the brace assembly is configured to support the actuator system and drive member such that
the press axis is aligned with the structural axis,
at least a portion of the brace assembly engages the actuator system and the structural assembly, and
at least a portion of the drive member engages the actuator system and the bushing assembly; and
operation of the actuator system displaces the drive member and bushing assembly along the press axis relative to the retaining sleeve and structural member until the bushing assembly is in a desired position defined by the structural member.

16. The press tool system of claim 15, in which the brace assembly comprises a brace rod configured to support the drive member and bushing assembly such that when the actuator system is operated, the drive member and bushing assembly are displaced along the brace rod.

17. The press tool system of claim 15, in which the brace assembly comprises a brace rod and an anchor nut, whereby
the brace rod is configured to engage the actuator system,
the anchor nut is configured to engage the structural member and brace rod such that the actuator system maintains a maximum distance from the structural member.

18. The press tool of claim 17 in which the anchor nut defines an anchor passageway and the actuator system is configured to displace the drive member until at least a portion of the bushing assembly is arranged within the anchor passageway.

19. The press tool system of claim 15, in which the retaining sleeve defines a drive interior surface defining the sleeve passageway, wherein the drive interior surface is configured to engage the bushing assembly as the bushing assembly is displaced along the press axis.

20. The press tool system of claim 15, in which the actuator system comprises a piston member configured to engage the drive member as the actuator system is operated.
